(19) United States
(12) Patent Application Publication
(10) Pub. No.: US 2012/0216704 A1
(43) Pub. Date: Aug. 30, 2012

(54) POWER MODULE ENCLOSURE FOR LOCOMOTIVE

(76) Inventors: Geary W. Smith, JR., Peoria, IL (US); Csaba A. Bernad, Peoria, IL (US); David L. Davis, Canton, IL (US)

(21) Appl. No.: 13/037,144

(22) Filed: Feb. 28, 2011

(51) Int. Cl. B61C 7/04; B23P 11/00; B61C 17/00

(52) U.S. Cl. 105/35; 105/26.05; 29/428

(57) ABSTRACT

A power module enclosure for a machine is disclosed. The power module enclosure may have a first frame with a first side removably attached to a base platform of the machine at an engine location, a second side removable attached to the base platform opposite the first side, and a third side disposed between and fixedly connected to the first and second sides along a length direction of the first and second sides. The power module enclosure may also have a plurality of doors pivotally connected to at least one of the first and second sides to close off the at least one of the first and second sides, and an aftertreatment module connected to the third side to close off the third side.

### TECHNICAL FIELD

The present disclosure relates generally to a power module enclosure and, more particularly, to a power module enclosure for a locomotive.

### BACKGROUND

Locomotives include a power module for generating power that drives the locomotive and supplies auxiliary demands. The power module often includes an internal combustion engine that drives one or more electric generators to produce electricity. The power module is generally located within a housing that separates the engine and/or generator from its surroundings to reduce an amount of heat and noise transfer, as well as to protect the engine and generator from the elements. In order to service, inspect, and/or repair the power module, at least a portion of the housing is often removed to gain sufficient access to the power module. Gaining access to the power module by removing portions of the housing can be labor intensive and time consuming. In addition, packaging of increasingly complex aftertreatment systems within the housing can be difficult.

One example of a simplified locomotive housing is described in European Patent No. 1,896,892 of Willmoore that issued on Feb. 13, 2008 (the '892 patent). In particular, the '892 patent discloses a locomotive having a housing that encloses an engine and supports an aftertreatment module. The aftertreatment module includes a particulate filter and a reduction catalyst. The aftertreatment module extends an entire width of the housing and a length of the engine, and is integrated into the housing roof and supported at its sides. The aftertreatment module can be lifted upwards away from the engine for improved servicing of the module and engine.

Although the locomotive housing of the '892 patent may have improved access for servicing purposes, it may still be less than optimal. In particular, the access provided to the engine may be from only one direction, that is from the top. This type of access may be inconvenient when only a side of the engine requires servicing. In addition, the connection between the aftertreatment module and the rest of the housing may provide opportunities for precipitation to enter the housing. Further, the connection between the aftertreatment module and the housing may require high precision machining in order to ensure proper connections between the aftertreatment module and the engine.

The power module enclosure of the present disclosure solves one or more of the problems set forth above and/or other problems in the art.

### SUMMARY

In one aspect, the present disclosure is directed to a power module enclosure for a machine. The power module enclosure may include a first frame with a first side removably attached to a base platform of the machine at an engine location, a second side removably attached to the base platform opposite the first side, and a third side disposed between and fixedly connected to the first and second sides along a length direction of the first and second sides. The power module enclosure may also include a plurality of doors pivotally connected to at least one of the first and second sides to close off the at least one of the first and second sides, and an aftertreatment module connected to the third side to close off the third side.

In another aspect, the present disclosure is directed to method of assembling a power module enclosure. The method may include removably fastening a first frame to a base platform of a machine at an engine location, and slidingly interlocking a second frame with the first frame in a direction generally perpendicular to the base platform. The method may further include removably fastening the second frame to the base platform at a generator location.

### BRIEF DESCRIPTION OF THE DRAWINGS

FIG. 1 is a pictorial illustration of an exemplary disclosed locomotive;

FIG. 2 is a pictorial illustration of an exemplary disclosed power module enclosure that may be used in conjunction with the locomotive of FIG. 1;

FIG. 3 is a pictorial illustration of an exemplary disclosed portion of the power module enclosure of FIG. 2;

FIG. 4 another pictorial illustration of the disclosed power module enclosure that may be used in conjunction with the locomotive of FIG. 1; and

FIG. 5 is a pictorial illustration of another exemplary disclosed portion of the power module enclosure of FIG. 4.

### DETAILED DESCRIPTION

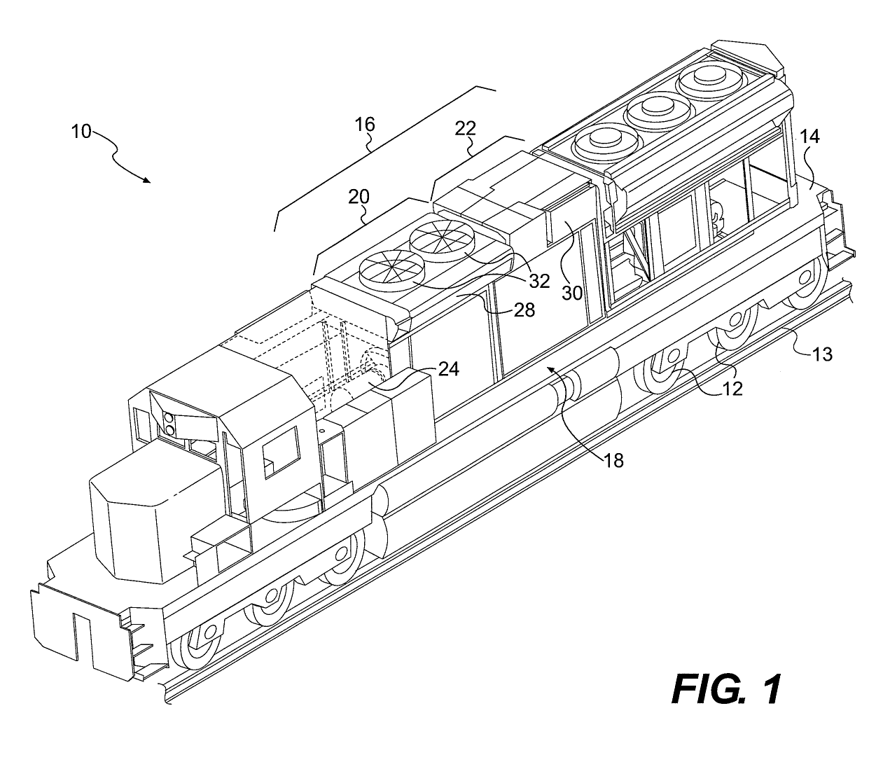

FIG. 1 illustrates a locomotive 10 having a plurality of wheels 12 configured to engage a track 13, a base platform 14 supported by wheels 12, and one or more power modules 16 mounted to base platform 14 and configured to drive wheels 12. Any number of power modules 16 may be included within locomotive 10 and operated to produce power that may be transferred to one or more traction motors (not shown) used to drive wheels 12. In the exemplary embodiment shown in FIG. 1, locomotive 10 may include a single power module 16 aligned on base platform 14 along a length or travel direction of locomotive 10.

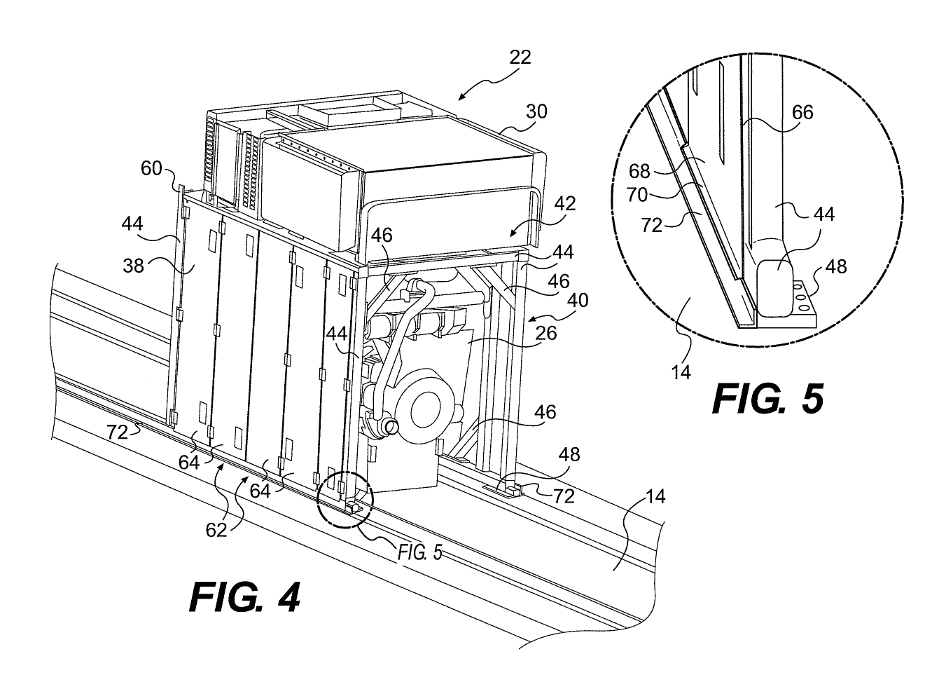

Each power module 16 may be at least partially covered by an enclosure 18 and divided into a generator section 20 and an engine section 22 located rearward of generator section 20. Generator section 20 may house a generator 24 that is driven by an engine 26 (shown only in FIG. 4), which may be housed within engine section 22. Generator 24 may be, for example, an AC induction generator, a permanent-magnet generator, an AC synchronous generator, or a switched-reluctance generator that is mechanically driven by engine 26 to produce electrical power. Engine 26 may be an internal combustion engine such as a diesel engine, a gasoline engine, or a gaseous-fuel powered engine that combusts a mixture of fuel and air to generate a mechanical input to generator 24. A dynamic brake 28 may close off and form the roof of generator section 20, while an aftertreatment module 30 may close off and form the roof of engine section 22.

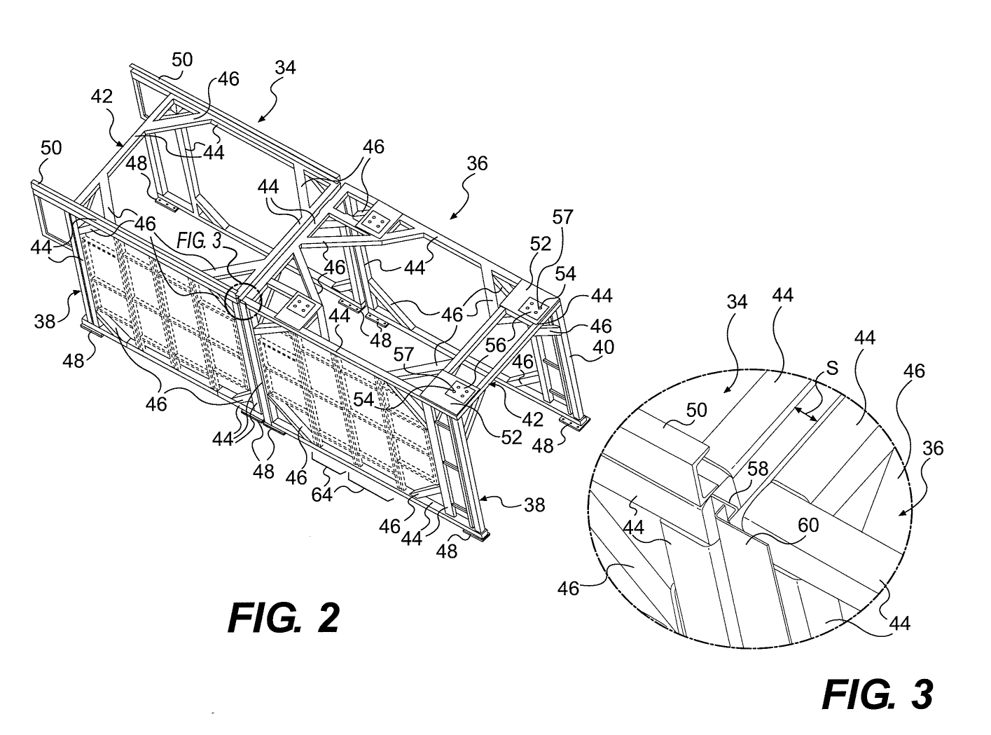

Dynamic brake 28 may include a resistive grid/fan combination associated with the motors that drive wheels 12. During a dynamic braking event, the motors can be operated as generators, using wheels 12 to apply torque and generate electricity. The torque applied by the wheels 12 may slow locomotive 10, while the electricity may be directed through a resistive grid (not shown) of dynamic brake 28. One or more fans 32 may be used to blow air through the grid during the braking event to cool the grid and exhaust heated air out of the locomotive. Dynamic brake 28 may be removably connected to a first frame 34 (shown only in FIG. 2) of generator section 20.

Aftertreatment module 30 may embody a modular assembly of exhaust treatment components contained within a common box-like housing. Aftertreatment module 30 may be used with many different engines 26 and/or power module configurations, be generally self-contained, and have a connection interface that facilitates exhaust, fluid, power, and/or data communication with other components of power module 16. In one example, placement of aftertreatment module 30 relative to engine 26 may require precision to help ensure proper alignment with exhaust, fluid, power, and/or data communication conduits that run between aftertreatment module 30 and engine 26. Aftertreatment module 30 may be removably connected to a second frame 36 (shown in FIGS. 2 and 4) of engine section 22.

FIG. 2 shows the structure of first and second frames 34, 36. Each of first and second frames 34, 36 may generally include three sides, for example a first side 38 removably attachable to base platform 14 (referring to FIG. 4), a second side 40 removable attachable to base platform 14 opposite first side 38, and a third or top side 42 disposed between and fixedly connected to first and second sides 38, 40 along a length direction of first and second sides 38, 40. Each of first and second sides 38, 40 may be removably attachable to base platform 14 on opposing sides of generator 24 and engine 26 (referring to FIGS. 1 and 4) by way of threaded fasteners (not shown), while third side 42 may be fixedly connected to first and second sides 38, 40 over the tops of generator 24 and engine 26 via welding. In one embodiment, first and second sides 38, 40 may be substantially identical.

Each of first, second, and third sides 38-42 may be a rigid assembly consisting essentially of four outer frame members 44 and four inner corner supports 46. Each outer frame member 44 may be disposed generally perpendicular and permanently connected to (e.g., welded to) adjacent frame members 44 to form a box or rectangle. In one embodiment, third side 42 may share one frame member 44 with each of first and second sides 38, 40. At least one corner support 46 may be rigidly connected (e.g., welded) between each pair of adjacent frame members 44, and located in a corner of the box or rectangle formed by frame members 44 such that a generally open center within each of first, second, and third sides 38-42 may be provided for service access to generator 24 and/or engine 26. Frame members 44 located opposite third side 42 may include mounting pads 48 having any number of holes and/or fasteners for the removable connection of first and second frames 34, 36 to base platform 14. It is contemplated that first and/or second frames 34, 36 may include additional supports for adding structural rigidity or otherwise supporting one or more components of power module 16, if desired.

As shown in FIGS. 2 and 3, first frame 34 may include mounting geometry configured to receive dynamic brake 28. For example, first frame 34 may include a pair of opposing tracks 50 such as U- or C-shaped iron stock members configured to receive rails, wheels, pegs, or other similar protrusions (not shown) on opposing sides of dynamic brake 28 in a sliding manner. Tracks 50 may be fixedly positioned on opposing frame members 44 of third side 42, in alignment with the length direction of base platform 14 and enclosure 18. In this configuration, the protrusions of dynamic brake 28 may slide into tracks 50 of first frame 34 from an end thereof before first frame 34 is mounted to base platform 14 or, alternatively, after the mounting of first frame 34 to base platform 14 but prior to the mounting of aftertreatment module 30 to second frame 36.

Aftertreatment module 30 (referring to FIGS. 1 and 4) may be removably mounted to second frame 36 after second frame 36 and engine 26 are secured to base platform 14. In particular, as shown in FIG. 2, second frame 36 may include a first plurality of mounting pads 52, each having at least one oversized hole 54. Aftertreatment module 30 may similarly have a second plurality of mounting pads 56 configured to mate with mounting pads 52. Mounting pads 56 may each include at least one hole 57 having a diameter less than that of hole 54 (i.e., a nominal diameter) and configured to align with oversized hole 54 and receive a common threaded fastener (not shown). During assembly, mounting pads 56 may first be assembled to mounting pads 54 and secured in place via the threaded fasteners. Thereafter, aftertreatment module 30 may be precisely located relative to the already-mounted engine 26 (i.e., aftertreatment module 30 may be lowered into place over engine 26 with the appropriate exhaust, fluid, and data conduits connected), and then fixedly connected to mounting pads 56. In this manner, aftertreatment module 30 may subsequently be removed from second frame 36 by loosening the threaded fasteners from mounting pads 52 and 56, serviced, and replaced, while maintaining the correct spatial arrangement relative to engine 26. Spacers and/or shims may be utilized during the fixing of aftertreatment module 30 to mounting pads 56, as required.

First and second frames 34, 36 may each include geometry designed to reduce a likelihood of precipitation from entering enclosure 18 through a vertical space “s” between first and second frames 34, 36. In particular, each of first and second frames 34, 36 may include a generally L-shaped flange 58, 60 extending towards each other from vertical frame members 44 located on the trailing end of first frame 34 and the leading end of second frame 36, respectively. Flanges 58 of first frame 34 may be inverted relative to flanges 60 of second frame 36 such that flanges 58 overlap and interlock with flanges 60, thereby creating a weather seal between first and second frames 34, 36. In this configuration, first frame 34 and second frame 36 may be connected to each other by vertically sliding one of first and second frames 34, 36 into place on base platform 14 after the other of first and second frames 34, 36 has already been mounted to base platform 14. The space “s” may be maintained between first and second frames 34, 36 at flanges 58, 60 to accommodate movement of first and second frames 34, 36 during assembly and during operation of locomotive 10.

As shown in FIG. 4, at least first side 38 of engine section 22 may be equipped with a plurality of doors 62 that provides access to engine 26 via the open center between frame members 44. In one embodiment, doors 62 may be accordion-type doors, wherein a first of doors 62 may be hinged to a vertical frame member 44 of first side 38, while an adjacent door 62 may be hinged to only the first door 62, thereby allowing doors 62 to collapse against each other when opened. It is contemplated that second side 40 of engine section 22 and/or first and second sides 38, 40 of generator section 20 may be similarly equipped with doors 62, if desired.

Each door 62 may be an assembly of components including, among other things, an internal frame 64 (shown in FIG. 2) and an external cover 66 (shown in FIGS. 4 and 5). Internal frame 64 may include a supporting structure of hollow or solid parts such as beams or struts that are fixedly connected to each other, with spaces between the parts that function to reduce a weight of door 62. When enclosure 18 is fully assembled, internal frames 64 of doors 62 may be disposed within the open centers of first and second frames 34, 36 (i.e., in the same general plane as frame members 44 at first and second sides 38, 40). External cover 66 may be a stamped, welded, or molded component having a main surface 68 engaged with internal frame 64, and a lip 70 that is angled outward away from main surface 68. External cover 66 may be fixedly or removably connected to internal frame 64 by way of, for example, welding, riveting, or threaded fastening.

Enclosure 18 may be provided with geometry designed to reduce a likelihood of precipitation from entering enclosure 18 through an interface between base platform 14 and generator and engine sections 20, 22. Specifically, FIGS. 4 and 5 show a leak barrier 72 fixedly connected (e.g., welded) to base platform 14 on either side of generator and engine sections 20, 22. Each leak barrier 72 may extend in a length direction of base platform 14, from at least a leading end of generator section 20 to at least a trailing end of engine section 22. Leak barrier 72 may be a composite component consisting of multiple parts or, alternatively, a single integral component, as desired. When enclosure 18 is fully assembled and doors 62 are closed, first and second frames 34, 36 (referring to FIG. 2) and internal frames 64 of doors 62 may be located inward of leak barrier 72 (i.e., between opposing leak barriers 72), while distal edges of lips 70 may be located outward of leak barriers 72. In this configuration, precipitation that impinges doors 62 may be drawn by gravity downward toward base platform 14 and over lip 70 to drip on base platform 14 outward of enclosure 18.

### INDUSTRIAL APPLICABILITY

Although the disclosed power module enclosure may be applicable to different types of machines where access to contents of the enclosure is an important factor, the disclosed power module enclosure may find particular applicability with mobile machines such as locomotives that are exposed to and benefit from protection from the environment. The disclosed power module may provide improved access to the sides of the module via accordion-type doors and frames having large open centers. Even greater access can be provided by the complete removal of the enclosure's frames from the locomotive's base platform. Protection from the environment may be provided by interlocking flanges located between frame sections, and by way of length-wise leak barriers connected to the base platform.

It will be apparent to those skilled in the art that various modifications and variations can be made to the disclosed power module enclosure without departing from the scope of the disclosure. Other embodiments of the power module enclosure will be apparent to those skilled in the art from consideration of the specification and practice of the power module enclosure disclosed herein. It is intended that the specification and examples be considered as exemplary only, with a true scope of the disclosure being indicated by the following claims and their equivalents.

What is claimed is:

1. A power module enclosure for a machine, comprising:
a first frame having a first side removably attached to a base platform of the machine at an engine location, a second side removable attached to the base platform opposite the first side, and a third side disposed between and fixedly connected to the first and second sides along a length direction of the first and second sides;
a plurality of doors pivotally connected to at least one of the first and second sides to close off the at least one of the first and second sides; and
an aftertreatment module connected to the third side to close off the third side.

2. The power module enclosure of claim 1, wherein each of the first, second, and third sides includes:
four outer frame members, each of the four outer frame members disposed generally perpendicular and fixedly connected to adjacent ones of the four outer frame members;
at least four corner supports, each of the at least four corner supports extending between two of the four outer frame members; and
an open center between the at least four corner supports.

3. The power module enclosure of claim 2, wherein the first and second sides are connected by only the base platform at edges opposite the third side.

4. The power module enclosure of claim 1, wherein each of the plurality of doors includes an internal frame and an external cover.

5. The power module enclosure of claim 4, wherein each of the first and second plurality of doors includes at least a first door pivotally connected to a frame member, and at least a second door pivotally connected to the first door.

6. The power module enclosure of claim 4, further including at least one leak barrier fixedly connected to the base platform and extending in a length direction of the base platform, wherein:
the first side of the first frame is disposed inward of the at least one leak barrier; and
the external cover of at least one of the plurality of doors includes a lip disposed outward of the at least one leak barrier when closed.

7. The power module enclosure of claim 6, wherein the lip is angled outward from a main surface of the external cover.

8. The power module enclosure of claim 1, wherein the aftertreatment module includes a box-like housing and a plurality of treatment devices disposed within the housing.

9. The power module enclosure of claim 8, wherein the housing of the aftertreatment module forms a roof of the power module enclosure.

10. The power module enclosure of claim 8, further including:
a first mounting pad fixedly connected to the housing of the aftertreatment module and having at least one hole;
a second mounting pad fixedly connected to the third side of the first frame and having at least one oversized hole; and
a common fastener passing through the at least one hole in the first mounting pad and the at least one oversized hole in the second mounting pad.

11. The power module enclosure of claim 1, further including a second frame having a fourth side removably attached to the base platform of the machine at a generator location, a fifth side removable attached to the base platform opposite the fourth side, and a sixth side disposed between and fixedly connected to the fourth and fifth sides along a length direction of the fourth and fifth sides;
a plurality of doors pivotally connected to at least one of the fourth and fifth sides to close off the at least one of the fourth and fifth sides; and
a dynamic brake connected to the sixth side to close off the sixth side.

12. The power module enclosure of claim 11, wherein the first and second frames are disposed adjacent each other and include overlapping and interlocking flanges that extend in a direction away from the base platform.

13. The power module enclosure of claim 1, wherein the machine is a locomotive.

14. A method of assembling a power module enclosure, comprising:
removably fastening a first frame to a base platform of a machine at an engine location;
slidingly interlocking a second frame with the first frame in a direction generally perpendicular to the base platform; and
removably fastening the second frame to the base platform at a generator location.

15. The method of claim 14, further including:
removably fastening a first plurality of mounting pads to a second plurality of mounting pads that are fixedly connected to the first frame; and
fixedly connecting the first plurality of mounting pads to an aftertreatment module after fastening of the first plurality of mounting pads to the second plurality of mounting pads.

16. A locomotive comprising:
a plurality of wheels configured to engage a track;
a base platform supported by the plurality of wheels;
an engine mounted on the base platform;
a generator mounted on the base platform and driven by the engine to produce electricity;
a first frame having a first side removably attached to the base platform proximate the engine, a second side removable attached to the base platform proximate the engine and opposite the first side, and a third side disposed between and fixedly connected to the first and second sides along a length direction of the first and second sides;
an aftertreatment module connected to the third side to close off the third side;
a second frame having a fourth side removably attached to the base platform proximate the generator, a fifth side removable attached to the base platform proximate the generator and opposite the fourth side, and a sixth side disposed between and fixedly connected to the fourth and fifth sides along a length direction of the fourth and fifth sides;
a dynamic brake connected to the sixth side to close off the sixth side; and
a plurality of flanges that overlap each other and extend in a direction away from the base platform, the plurality of flanges forming a connection between the first and second frames.

17. The locomotive of claim 16, further including a plurality of doors pivotally connected to at least one of the first, second, fourth, and fifth sides to close off the at least one of the first, second, fourth, and fifth sides, wherein:
each of the plurality of doors includes an internal frame and an external cover; and
the plurality of doors includes at least a first door pivotally connected to a frame member, and at least a second door pivotally connected to the first door.

18. The locomotive of claim 17, further including at least one leak barrier fixedly connected to the base platform and extending in a length direction of the base platform, wherein:
the first, second, fourth, and fifth sides of the first and second frames are disposed inward of the at least one leak barrier; and
the external cover of at least one of the plurality of doors includes a lip angled outward of the at least one leak barrier when closed.

19. The locomotive of claim 16, wherein each of the first, second, third, fourth, fifth, and sixth sides includes:
four outer frame members, each of the four outer frame members disposed generally perpendicular and fixedly connected to adjacent ones of the four outer frame members;
at least four corner supports, each of the at least four corner supports extending between two of the four outer frame members; and
an open center between the at least four corner supports.

20. The locomotive of claim 16, wherein:
the aftertreatment module includes a box-like housing and a plurality of treatment devices disposed within the housing; and
the housing of the aftertreatment module forms a roof of the locomotive.
